(19) United States
(12) Patent Application Publication
(10) Pub. No.: US 2017/0004753 A1
(43) Pub. Date: Jan. 5, 2017

(54) DISPLAY DRIVING CIRCUIT HAVING BURN-IN RELAXING FUNCTION AND DISPLAY DRIVING SYSTEM INCLUDING THE SAME

(71) Applicant: SAMSUNG ELECTRONICS CO., LTD., SUWON-SI (KR)

(72) Inventors: YANGHYO KIM, SUWON-SI (KR); SOOYOUNG WOO, HWASEONG-SI (KR); DOKYUNG KIM, YONGIN-SI (KR); SANG-HOON OHN, HWASEONG-SI (KR)

(21) Appl. No.: 15/166,346

(22) Filed: May 27, 2016

(30) Foreign Application Priority Data
Jul. 3, 2015 (KR) 10-2015-0095300

(51) Int. Cl. G09G 3/20; G09G 3/3225

(52) U.S. Cl. CPC G09G 3/2003; G09G 3/3225; G09G 2310/08; G09G 2320/0233; G09G 2320/046; G09G 2320/0673

(57) ABSTRACT

A display driving circuit includes a gate driver configured to output a scanning signal, a source driver configured to output image data, a timing controller configured to control the gate driver and the source driver to drive the image data, and a burn-in managing circuit configured to determine whether input image data to be applied to the source driver is a still image to decide whether or not to enter a burn-in relax mode and to generate a burn-in relaxing control signal for burn-in relaxation according to a result of the decision.

### CROSS-REFERENCE TO RELATED APPLICATIONS

This US non-provisional patent application claims priority under 35 USC §119 to Korean Patent Application No. 10-2015-0095300, filed on Jul. 3, 2015, the disclosure of which is incorporated by reference herein.

### BACKGROUND

1. Technical Field

The present disclosure relates to display driving circuits to display images on a display panel and, more particularly, to a display driving circuit having a burn-in relaxing function.

2. Discussion of Related Art

A flat panel display (FPD) device may be used in various electronic devices such as a smartphone, a tablet PC, a laptop computer, a personal computer, and a TV. An organic light emitting diode (OLED) display device is a type of flat panel display device that employs an organic light emitting diode. An OLED display device has higher response speed, higher luminous efficiency, higher luminance, and a wider viewing angle than a liquid crystal display (LCD) device.

An OLED display device has a self-luminous characteristic to internally emit light when current flows to a fluorescent organic compound that is an organic light emitting material. If the organic light emitting material is injected between an anode and a cathode of an organic light emitting diode and current is made to flow between the anode and the cathode of the organic light emitting diode, electrons and holes are introduced into the organic light emitting material. The introduced electrons and the introduced holes are recombined to achieve self-luminescence.

In an OLED display device such as an active-matrix OLED (AMOLED) display device, burn-in often occurs at a pixel due to display driving characteristics. The term “burn-in” refers to a phenomenon in which a residual image is still visible when the same image is displayed on a screen for a long period of time. Due to typical aging according to pixel usage time and pixel aging caused by display of the same or repeated pixel, a driving voltage required for a pixel varies depending on usage time. Variation of the required driving voltage results in burn-in. In particular, since the life of an OLED having a blue color is shorter than that of OLEDs having other colors, burn-in occurs more frequently at an OLED that displays a blue color.

### SUMMARY

A display driving circuit according to an exemplary embodiment of inventive concept includes a gate driver configured to output a scanning signal, a source driver configured to output image data, a timing controller configured to control the gate driver and the source driver to display the image data, and a burn-in managing circuit configured to determine whether input image data to be applied to the source driver is a still image to decide whether or not to enter a burn-in relax mode and to generate a burn-in relaxing control signal for burn-in relaxation according to a result of the decision.

In an exemplary embodiment, the burn-in managing circuit may analyze input image data applied to a graphic memory from a host to determine whether the input image data is the still image.

In an exemplary embodiment, the burn-in managing circuit may analyze input image data output from a graphic memory receiving the input image data from a host and storing the input image data in a storage area of the graphic memory to determine whether the input image data is the still image.

In an exemplary embodiment, the burn-in managing circuit may include a first input detector configured to detect whether input image data received from a host is a still image, a second input detector configured to detect whether input image data provided to the source driver from a graphic memory is a still image, a decision circuit configured to decide whether or not enter the burn-in relax mode in response to detection outputs of the first and second detectors, and a control signal generator configured to generate the burn-in relaxing control signal for burn-in relaxation of a display panel in response to a decision result of the decision circuit.

In an exemplary embodiment, entering the burn-in relax mode may be executed when the still image is determined and maintained longer than a predetermined reference time.

In an exemplary embodiment, the burn-in relaxing control signal may be applied to a gamma circuit adjusting a gamma level to control the brightness of a display panel.

In an exemplary embodiment, the burn-in relaxing control signal may be applied to a brightness circuit adjusting a power supply voltage of a display panel to control the brightness of the display panel.

In an exemplary embodiment, the burn-in relaxing control signal may be applied to a pixel processing part regenerating display data and outputting the display data to the source driver to control the brightness of a display panel.

In an exemplary embodiment, the burn-in relaxing control signal may be applied to a timing controller adjusting an organic light emitting diode OLED emission pulse width modulation PWM to control the brightness of a display panel.

A display driving system according to an exemplary embodiment of inventive concept includes a host, a display driving circuit, and a display panel. The display driving circuit includes a burn-in managing circuit configured to determine whether applied image data is a still image or a video to decide whether or not to enter a burn-in relax mode and to generate a burn-in relaxing control signal for burn-in relaxation according to a result of the decision.

In an exemplary embodiment, the burn-in managing circuit may analyze input image data applied to a graphic memory from a host to determine whether the input image data is a still image or analyze input image data output from a graphic memory receiving input image data from a host and storing the input image data in a storage area of the graphic memory to determine whether the input image data is a still image.

In an exemplary embodiment, the display driving system may further include a pattern refresh circuit configured to refresh a specific pattern to the display panel when entering the burn-in relax mode.

In an exemplary embodiment, the display driving system may further include a frame rate adjuster configured to variably adjust a frame rate of the display panel when entering the burn-in relax mode.

A display driving circuit according to an exemplary embodiment of the inventive concept includes a gate driver configured to output a scanning signal, a source driver configured to output image data, a timing controller configured to control the gate driver and the source driver to display the image data, and a burn-in managing circuit configured to determine whether input image data to be applied to the source driver is a still image or a moving image, apply a signal at a first level to enter a burn-in relax mode when it determines the input image data is the still image, and apply the signal at a second other level to exit the burn-in relax mode or enter a normal display mode when it determines the input image data is the moving image.

In an embodiment, the display driving circuit further includes a plurality of internal signal lines, wherein the burn-in managing circuit is configured to apply the signal to a selected one of the internal signal lines.

In an embodiment, wherein the selected one of the internal signal lines connects the burn-in managing circuit to the timing controller, and the signal causes the timing controller to set a pulse width modulation signal to change a pixel brightness of one or more pixels of a display panel when the signal is applied at the first level and maintain the pixel brightness when the signal is applied at the second level.

In an embodiment, the display driving circuit further includes a gamma circuit, wherein the selected one of the internal signal lines connects the burn-in managing circuit to the gamma circuit, and the signal causes the gamma circuit to change a gamma level when the signal is applied at the first level and maintain the gamma level when the signal is applied at the second level.

In an embodiment, the display driving circuit further includes a brightness circuit, wherein the selected one of the internal signal lines connects the burn-in managing circuit to the brightness circuit, and the signal causes the brightness circuit to change a power supply voltage of a display panel when the signal is applied at the first level and maintain the power supply voltage when the signal is applied at the second level.

### BRIEF DESCRIPTION OF THE DRAWINGS

The inventive concept will be described below in more detail with reference to the accompanying drawings in which like reference characters refer to like parts throughout the different views. In the drawings:

FIG. 1 is a block diagram of a display driving circuit according to an exemplary embodiment of inventive concept;

FIG. 2 is a block diagram of a display driving system according to an exemplary embodiment of inventive concept;

FIG. 3 is a detailed block diagram of a burn-in managing circuit in FIG. 1 or 2 according to an exemplary embodiment of inventive concept;

FIG. 4 is an exemplary circuit diagram of a pixel in FIG. 1 or 2;

FIG. 5 is a flowchart of burn-in managing control according to an exemplary embodiment of inventive concept;

FIG. 6 is a block diagram illustrating an example where a burn-in relaxing control signal generated according to FIG. 5 is used in a gamma circuit;

FIG. 7 is a block diagram of an application example applied to a data processing system; and

FIG. 8 is a block diagram of an application example applied to a portable computing system.

### DETAILED DESCRIPTION

Embodiments of the inventive concept will now be described more fully through the following particular embodiments related to the accompanying drawings. However, embodiments of the inventive concept are not limited to these particular embodiments and may take other forms.

It will be understood that when an element is referred to as being “connected” or “coupled” to another element, it can be directly connected or coupled to the other element or intervening elements may be present.

As used herein, the singular forms “a”, “an”, and “the” are intended to include the plural forms as well, unless the context clearly indicates otherwise.

Moreover, the same or like reference numerals in each of the drawings represent the same or like components. In some drawings, the connection of elements and lines is represented to effectively explain technical content and may further include other elements or circuit blocks.

Note that each embodiment that is herein explained and exemplified may also include its complementary embodiment, and the details of basic data access operations to an OLED display device and internal function circuits and the details of a module structure and a structure or shape of a module tab area may not be described.

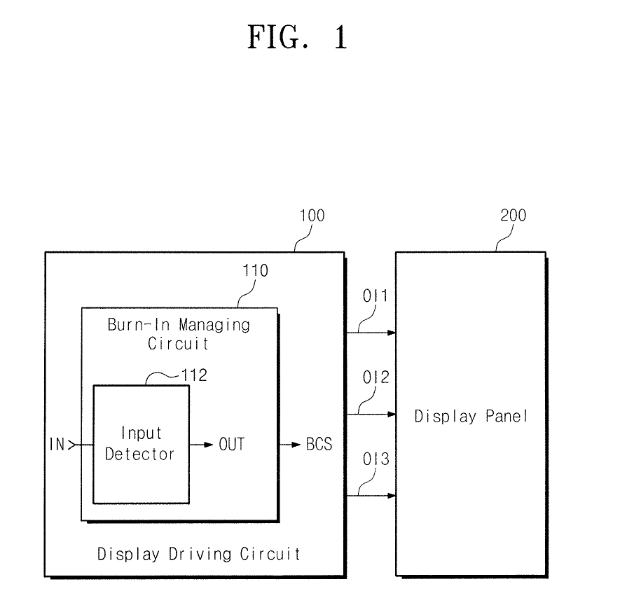

FIG. 1 is a block diagram of a display driving circuit 100 according to an exemplary embodiment of inventive concept. As illustrated, the display driving circuit 100 includes a burn-in managing circuit 110. The display driving circuit 100 drives a display panel 200.

The burn-in managing circuit 110 includes an input detector 112 and generates a burn-in relaxing control signal BCS. The burn-in managing circuit 110 applies the burn-in relaxing control signal BCS to a selected one or more of output lines L1-L4. The selection of the one or more output lines may be set using a pre-defined parameter stored in memory (e.g., 120). For example, the parameter could indicate that signal BCS is to be applied to just output line L1, just output line L2, output lines L1 and L2, output lines L1 and L3, etc. The input detector 112 may detect whether input image data IN received from a system-on-chip (SoC) is a still image or detect whether input image data IN output from a graphic memory is a still image. The input image data IN is applied through an input terminal of the input detector 112. A detection output OUT indicating whether the input image data is a still image may appear at an output terminal of the input detector 112.

The display driving circuit 100 may provide a scanning signal to the display panel 200 through a gate output line OI1. The display driving circuit 100 may provide image data to the display panel 200 through a source output line OI2. The display driving circuit 100 may provide a brightness control signal to the display panel 200 through an output line OI3. The brightness control signal may indicate a particular brightness level for set the display panel 200.

In the display driving circuit 100 of FIG. 1, the burn-in managing circuit 110 determines whether input image data IN to be output through the source output line OI2 is a still image to decide whether or not to enter a burn-in relax mode. If the burn-in managing circuit 110 decides it should enter the burn-in relaxing mode, the burn-in managing circuit 110 generates a burn-in relaxing control signal BCS for burn-in relaxation. In an embodiment, during entry of the burn-in relax mode, one or more actions are performed that causes one or more pixels of the display panel 200 to return to their relaxed state to eliminate or reduce image retention. The action(s) may be triggered by generation of the burn-in relaxing control signal BCS.

In order to relax or minimize burn-in, the burn-in relax control signal BCS may be used in adjusting a gamma level to control the brightness of the display panel 200 or in controlling brightness to adjust a power supply voltage of the display panel 200. The burn-in relaxing control signal BCS may be used in regenerating display data to control the brightness of the display panel 200 or in adjusting OLED emission pulse width modulation (PWM) to control the brightness of the display panel 200.

Accordingly, burn-in that may occur in the display panel 200 may be minimized or relaxed. As a result, the life of the display panel 200 may be improved to enhance the competitiveness of a display panel.

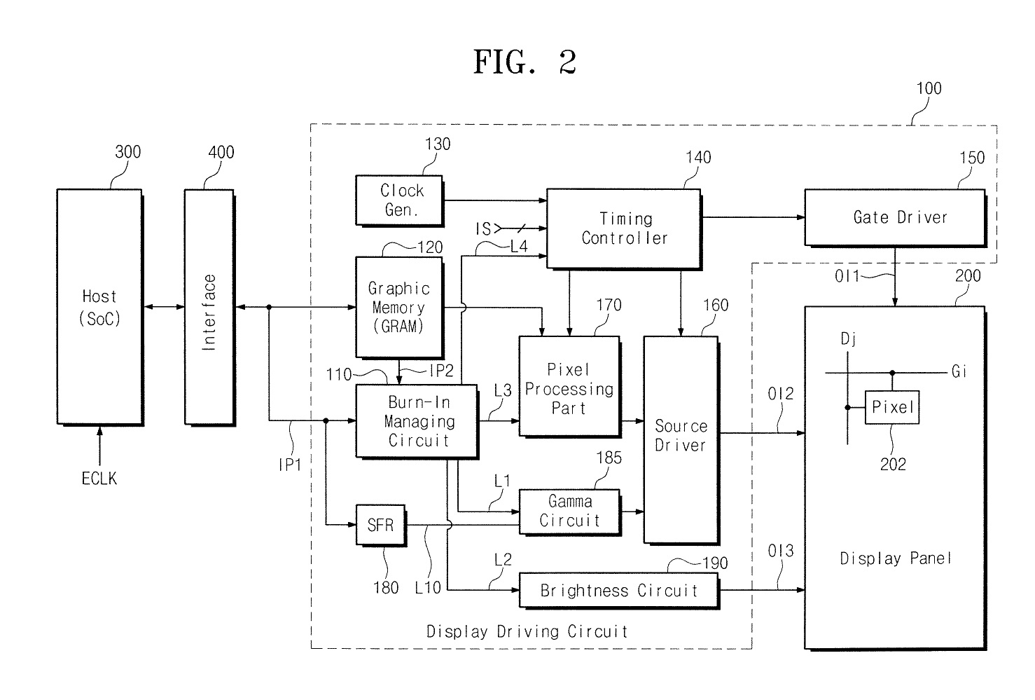

FIG. 2 is a block diagram of a display driving system according to an exemplary embodiment of inventive concept. As illustrated, the display driving system includes a display driving circuit 100, a display panel 200, a host 300, and an interface 400.

The host 300 may be implemented with an application processor (hereinafter referred to as “AP”) of an SoC structure. That is, in an embodiment of the AP, a central processing unit (CPU), a graphical processing unit (GPU), and an interface circuit are mounted on a single chip. The host 300 controls the overall operation of the display driving system and inputs and outputs data packets having display data in response to a clock signal ECLK. The data packet may include display data, a horizontal synchronization signal Hsyn, a vertical synchronization signal Vsyn, and a data enable signal DE. If the AP is mounted on a smartphone, the AP may be a mobile AP driven in an operating system (OS) such as Android™, iOS™, Windows Phone™, Bada™, BlackBerry™, and Symbian™.

The display driving circuit 100 may be implemented with a display driver integrated circuit (DDI). The display driving circuit 100 receives the data packets from the host 300 through the interface 400 and outputs the horizontal synchronization signal Hsyn, the vertical synchronization Vsyn, the data enable signal DE, display data RGB Data, and a clock PCLK. The interface 400 may be a high-speed serial interface such as mobile industry processor interface (MIPI), a mobile display digital interface (MDDI), a compact display port (CDP), a mobile pixel link (MPL), and current mode advanced differential signaling (CMADS). In the driving system, an interfacing operation is typically performed according to an MIPI standard. However, exemplary embodiments of inventive concept are not limited thereto.

The display driving circuit 100 includes a burn-in managing circuit 110, as described with reference to FIG. 1. In addition, the display driving circuit 100 may include a graphic memory 120, a clock generator 130, a timing controller 140, a gate driver 150, a source driver 160, a pixel processing part (e.g., circuit) 170, a special function register (SFR) 180, a gamma circuit 185, and a brightness circuit 190.

The graphic memory 120 may be provided for high-speed serial interface with the host 300. The graphic memory 120 may be implemented with a graphic random access memory (GRAM). Use of the GRAM may contribute to a decrease in current consumption, product heating, and the load of a host. The GRAM may write display data input from a host (e.g., 300), i.e., input image data into an internal storage area and output the written data through a scanning operation. In an exemplary embodiment, the GRAM is implemented with a dual port DRAM.

In an embodiment, after buffering a data packet without use of the graphic memory 120, the display driving circuit 100 outputs display data to achieve another high-speed serial interface with the host 300.

In an exemplary embodiment, the display driving circuit 100 employs the GRAM 120. However, the inventive concept is not limited thereto. For example, in an embodiment, the GRAM 120 is omitted.

The clock generator 130 may generate a display clock signal to process input image data using an MIPI clock signal and an oscillation clock signal.

The timing controller 140 receives an internal clock signal output from the clock generator 130 and receives a control signal provided from the interface 400 through an input signal terminal IS. The timing controller 140 outputs timing control signals to drive the gate driver 150 and the source driver 160 using the control signal. In an embodiment, the timing controller 140 outputs an OLED emission PWM signal to control pixel brightness of the display panel 200. In an embodiment, the OLED emission PWM signal has a first pattern or first value when the display driving circuit 100 has entered the burn-in relax mode, and has a second pattern or second value when the display driving circuit 100 exits the burn-in relax mode or enters a normal mode, where the first pattern differs from the second pattern and the first value differs from the second value. Data transmission between the interface 400 and the timing controller 140 may be carried out using low voltage differential signaling (LVDS), which is a manner of transmitting data. The LVDS uses multiplexing and differential amplification signal technologies to transmit massive amounts of information at a high speed. The LVDS is robust against noise and electromagnetic interference (EMI).

The gate driver 150 outputs a scanning signal in response to the control of the timing controller 140. A sequentially scanned turn-on voltage is applied to a gate electrode of each pixel of the display panel 200. The gate driver 150 may be implemented with a circuit having a plurality of output terminals. In an embodiment, the number of the output terminals is determined according to the resolution of the display panel 200. If the resolution of the display panel 200 increases, a plurality of drivers may be connected in parallel to implement the gate driver 150. The scanning signal may be a pulse-type signal generated with two levels of a turn-on voltage and a turn-off voltage. At a random point of time, the turn-on voltage is output from only one output terminal and the turn-off voltage is output from the other output terminals. That is, at a random point of time, pixels of the display panel 200 connected to a single gate wiring (e.g., Gi) are always in turn-off state and pixels of the display panel 200 connected to the other gate wiring are always in a turn-on state. That is, the gate driver 150 sequentially scans the gate wirings to apply a signal. When the gate driver 150 places a pixel in a turn-on state by selecting a gate wiring to apply a scanning signal, the source driver 160 applies a signal voltage to each pixel through a signal wiring.

The source driver 160 applies image data to each pixel in the form of a signal voltage. That is, if the gate driver 150 applies a pulse to a gate wiring of the display panel 200 to place a pixel in a turn-on state, the source driver 160 serves to apply a voltage required for a pixel of the display panel 200 through a data wiring (e.g., Dj). As compared to an analog driving manner, the source driver 160 of a digital manner may minimize an influence of noise during signal processing. In addition, the source driver 160 may use a logic gate to transform a signal and store a signal in a memory. As a result, the source driver 160 converts a digital image signal applied as input image data into a corresponding grayscale voltage and applies the grayscale voltage to each pixel electrode of the display panel 200. That is, the source driver 160 converts digitalized image data into each pixel voltage and applies the digitalized image data to a signal wiring (e.g., a data wiring).

The pixel processing part 170 may process the input image data output from the graphic memory 120 to reproduce display image data. The reproduced display image data may be applied to the source driver 160 through a shift register.

The special function register (SFR) 180 may receive SFR information required to process the input image data through a line IP1 and store the received SFR information in an internal register area. The SFR information may include frame synchronous information that needs to be synchronized in units of frames and frame asynchronous information that need not be synchronized in units of frames. For example, the frame synchronous information may include an image size (e.g., 1024*768) and an image color format (RGB, YCBCr, etc.).

The gamma circuit 185 generates a gamma signal as an operation reference signal for a digital-to-analog converter (DAC) used in the source driver 160. The gamma signal may be set by a producer on the basis of transmission-voltage characteristics and vary depending on adoption of a variable resistance. That is, if the gamma circuit 185 includes a capacitor and a plurality of resistors connected between a power supply voltage terminal and a ground voltage terminal, an output gamma voltage may vary with variation in resistance of the variable resistor.

The brightness circuit 190 may adjust a power supply voltage of the display panel 200 to control the brightness of the display panel 200. In an embodiment, the brightness circuit 190 increases the brightness of the display panel 200 by increasing the power supply voltage and decreases the brightness by decreasing the power supply voltage.

The display driving circuit 100 in FIG. 2 may further include a pattern refresh circuit to refresh a specific pattern to the display panel 200 when entering a burn-in relax mode. In addition, the display driving circuit 100 in FIG. 2 may further include a frame rate adjuster to variably adjust a frame rate of the display panel 200 when entering the burn-in relax mode. The burn-in managing circuit 110 in FIG. 2 may provide a burn-in relaxing control signal BCS for burn-in relaxation to the pattern refresh circuit or the frame rate adjuster. In an embodiment, the pattern refresh circuit alternates between presenting at least two different patterns on the display panel 200 when the burn-in relax mode has been entered. In an embodiment, the frame rate adjuster sets a frame rate of the display panel 200 to a first value when the burn-in relax mode has been entered, and sets the frame rate of the display panel 200 a second value when the burn-in relax mode has been exited or a normal display mode has been entered, where the first value is different from the second value.

In FIG. 2, the burn-in managing circuit 110 receives input image data through the first input terminal IP1 to determine whether input image data to be output through the source output line OI2 is a still image. The input image data received through the first input terminal IP1 is input image data applied to the graphic memory 120 from the host 300.

In addition, the burn-in managing circuit 110 may receive input image data through a second input terminal IP2 to determine whether input image data to be output through the source output line OI2 is a still image. The input image data received through the second input terminal IP2 is input image data output from the graphic memory 120. The input image data output from the graphic memory 120 may be different from the input image data received through the first input terminal IP1 by actions of a user or other controls.

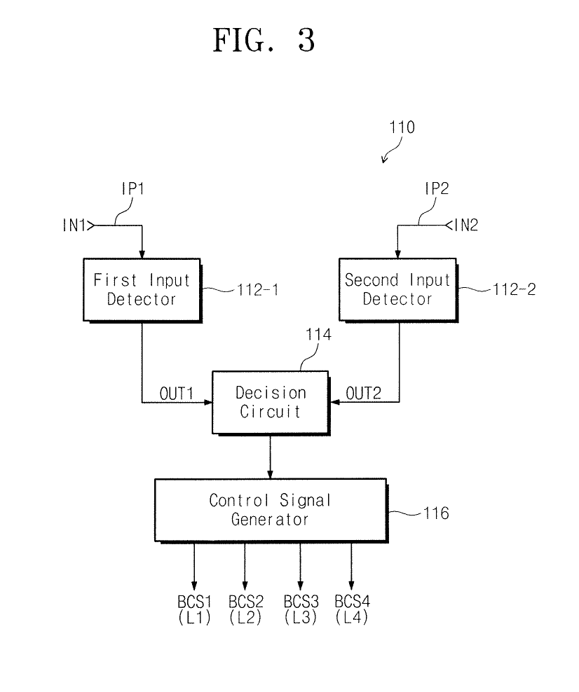

In an exemplary embodiment, the burn-in managing circuit 110 includes circuit blocks shown in FIG. 3, which are used to decide whether or not to enter a burn-in relax mode more accurately and precisely.

When the burn-in managing circuit 110 decides to enter the burn-in relax mode, the burn-in managing circuit 110 may generate various types of burn-in relaxing control signals BCS for burn-in relaxation through output lines L1, L2, L3, and L4. In an embodiment, the burn-in relax control signal BCS is set to a first value when the burn-in relax mode is entered and to a second value when the burn-in relax mode is exited or the normal display mode is entered, where the first value is different from the second value.

In order to relax or minimize burn-in, the burn-in relaxing control signal BCS may be used in adjusting a gamma level to control the brightness of the display panel 200. To achieve this, the burn-in relax control signal BCS may be provided to the gamma circuit 185 through the output line L1. In an embodiment, the gamma level is set to a first level by the gamma circuit 185 in response to receipt by the gamma circuit 185 of the burn-in relax control signal BCS set to the first value through output line L1, and the gamma level is set to a second level by the gamma circuit 185 in response to receipt by the gamma circuit 185 of the burn-in relax control signal BCS set to the second value through output line L1, where the first level is different from the second level.

In order to relax or minimize burn-in, the burn-in relaxing control signal BCS may be used in controlling brightness to adjust a power supply voltage of the display panel 200. To achieve this, the burn-in relaxing control signal BCS may be provided to the brightness circuit 190 through the output line L2. In an embodiment, the power supply voltage is set to a first voltage by the brightness circuit 190 in response to receipt by the brightness circuit 190 of the burn-in relax control signal BCS set to the first value through output line L2, and the power supply voltage is set to a second voltage by the brightness circuit 190 in response to receipt by the brightness circuit 190 of the burn-in relax control signal BCS set to the second value through output line L2, where the first voltage is different from the second voltage.

The burn-in relaxing control signal BCS may be used in reproducing display data to control the brightness of the display panel 200. To achieve this, the burn-in relaxing control signal BCS may be provided to the pixel processing part 170 through the output line L3.

The burn-in relaxing control signal BCS may be used in adjusting OLED emission PWM to control the brightness of the display panel 200. To achieve this, the burn-in relaxing control signal BCS may be provided to the timing controller 140 through the output line L4. In an embodiment, the OLED emission PWM signal output by the timing controller 140 is set to a first pattern in response to receipt by the timing controller 140 of the burn-in relax control signal BCS set to the first value through output line L4, and the OLED emission PWM signal is set to a second pattern in response to receipt by the timing controller 140 of the burn-in relax control signal BCS set to the second value through output line L4, where the first pattern is different from the second pattern.

Accordingly, burn-in of a pixel 202 that may occur in the display panel 200 may be minimized or relaxed. As the burn-in is relaxed, the life of the display panel 200 is improved to enhance product competitiveness of the display panel 200.

The display driving system in FIG. 2 may further include a DC/DC converter, a grayscale voltage generation circuit, and a common voltage generation circuit that are disposed inside or outside the display driving circuit 100.

The DC/DC converter may supply power required for operation of the display driving circuit 100.

The grayscale voltage generation circuit may nonlinearly convert a relationship between grayscale and signal intensity. The grayscale refers to the number of brightness levels visible on an image pixel. Although a relationship between grayscale and the amount of transmission may be linearly changed in theory, a signal is converted according to a gamma value to minutely express low brightness of a light source because human vision sufficiently recognizes a brightness difference of a dark light source but does not sufficiently recognize a brightness difference of a bright light source. For example, a 256-step brightness may be implemented with an 8-bit image signal, which is called 256 grayscale. It is reported that human vision generally recognizes brightness increase with grayscale increase to be nearly successive in 128 grayscales or more. Therefore, if 256 grayscales are implemented, nearly the same image as an analog grayscale may be expressed.

The common voltage generation circuit generates a voltage required for a common electrode on a substrate of the display panel 200. The magnitude of an applied voltage may be adjusted to control the brightness of a pixel. A variable voltage corresponding to the brightness of the pixel may be applied to a pixel electrode of the display panel 200, and a reference DC voltage may be applied to a color filter substrate and is called a common voltage. As a result, the common voltage generation circuit serves to provide the common voltage.

In FIG. 2, the display panel 200 may display data in units of frames. The display panel 200 may be one of an organic light emitting display panel (OLED), a liquid crystal display panel (LCD), a plasma display panel (PDP), an electrophoretic display panel, and an electrowetting display panel. However, the display panel 200 according to exemplary embodiments of inventive concept is not limited to this list.

FIG. 3 is a detailed block diagram of a burn-in managing circuit 110 in FIG. 1 or 2 according to an exemplary embodiment of the inventive concept. As illustrated, the burn-in managing circuit 110 includes a first input detector 112-1, a second input detector 112-2, a decision circuit 114, and a control signal generator 116.

The first input detector 112-1 receives input image data through a first input terminal IN1 to detect whether the input image data received from a host is a still image. The second input detector 112-2 receives input image data through a second input terminal IN2 to detect whether input image data provided to the source driver 160 is a still image.

The decision circuit 114 decides whether or not to enter a burn-in relax mode in response to detection outputs of the first and second detectors 112-1 and 112-2. The decision circuit 114 receives a first detection output from an output terminal OUT1 of the first detector 112-1. The decision circuit 114 receives a second detection output from an output terminal OUT2 of the second detector 112-2. The decision circuit 114 may perform an OR operation on the first and second detection outputs. That is, when one of the first and second detection outputs is detected as a still image, entering a burn-in mode is decided as a decision result.

The control signal generator 116 may generate the burn-in relaxing control signal BCS for burn-in relaxation of the display panel 200 in response to the decision result of the decision circuit 114. The control signal generator 116 may select one of the output lines L1-L4, and then output the burn-in relaxing control signal BCS to the selected output line.

The burn-in managing circuit 110 described with reference to FIG. 3 is merely exemplary, and exemplary embodiments of inventive concept are not limited thereto.

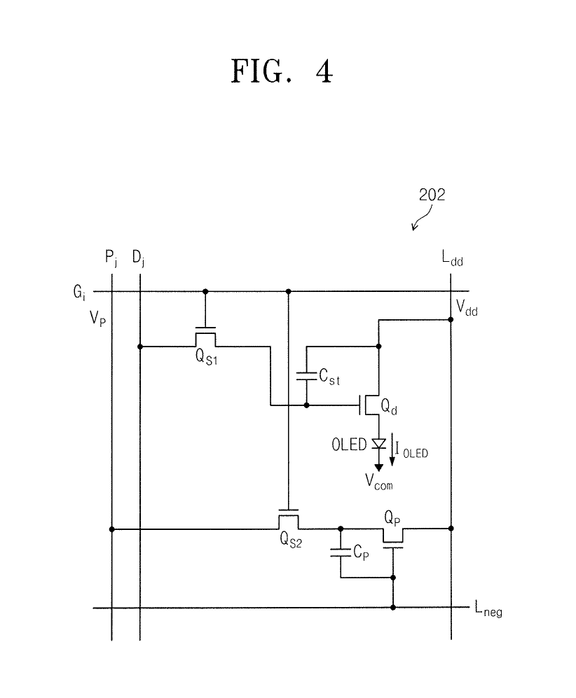

FIG. 4 is an exemplary circuit diagram of a pixel in FIG. 1 or 2. As illustrated, each pixel includes a driving transistor Qd, a switching transistor QS1, a storage capacitor Cst, and an organic light emitting diode (OLED).

The driving transistor Qd has a control terminal, an input terminal, and an output terminal. The control terminal is connected to the switching transistor QS1, the input terminal is connected to a driving voltage Vdd, and the output terminal is connected to the OLED. The driving transistor Qd transfers, to the OLED, output current IOLED whose intensity is controlled according to the magnitude of a voltage Vgs applied between the control terminal and the output terminal.

The switching transistor QS1 is coupled between a data line Dj and the driving transistor Qd and transmits a data signal applied to the data line Dj to the driving transistor Qd according to a scanning signal applied to a scanning signal line Gi.

The storage capacitor Cst is coupled between the control terminal and the input terminal of the driving transistor Qd and accumulates a data signal applied to the control terminal of the driving transistor Qd and stores the accumulated data signal during one frame.

A cathode of the OLED is connected to a common voltage Vcom and an anode thereof is connected to the output terminal of the driving transistor Qd. The OLED emits light according to the output current IOLED from the driving transistor Qd. That is, when forward current IOLED is applied to the OLED, electrons and holes migrate to a light emitting layer between the anode to provide the holes and the cathode to provide the electrons. The electrons and the holes are combined to emit light corresponding to a predetermined energy difference.

Each pixel may include an optical sensor which may include a sensing transistor QP connected to signal lines Ldd and Lneg, a switching transistor QS2 connected to signal lines Gi and Pj, and a sensing signal capacitor CP connected to the sensing transistor QP and the switching transistor QS2.

An input terminal of the sensing transistor QP is connected to the driving voltage line Ldd. A control terminal of the sensing transistor QP is connected to the reverse bias voltage line Lneg and the sensing signal capacitor CP. An output terminal of the sensing transistor QP is connected to the sensing signal capacitor CP and the switching transistor QS2. The sensing transistor QP is disposed below the OLED and receives light emitted from the OLED to generate optical current. Due to the driving voltage Vdd applied to the driving voltage line Ldd, the optical current flows in a direction of the sensing signal capacitor CP and the switching transistor QS2.

The sensing signal capacitor CP is coupled between the control terminal and the output terminal of the sensing transistor QP and accumulates charges according to the optical current from the sensing transistor QP to maintain a predetermined voltage. The sensing signal capacitor CP may be omitted, if necessary.

The switching transistor QS2 is coupled between a sensing signal line Pj and the sensing transistor QP. When a gate-on voltage is applied to the scanning signal line Gi to turn on the switching transistor QS2, the switching transistor QS2 outputs a voltage stored in the sensing signal capacitor CP or optical current from the sensing transistor QP to the sensing signal line Pj as a sensing signal VP.

As described with reference to FIG. 4, a pixel of the display panel is an example of an OLED configuration and exemplary embodiments of inventive concept are not limited thereto.

When a still image persists for a long period of time, a barrier fluorescent substance may become worn out to generate a residual image between a bright portion and a dark portion. When a still image is switched to another image after persisting for a long period of time without quick response to input image data, a residual image of the previous still image is generated. The residual image causes the whole image quality to be degraded. That is, an issue associated with an OLED display causes a “burn-in”. The time driven for the current and temperature given to a plurality of OLED material systems increases a driving voltage, which may be associated with a reduction in device efficiency.

As described above, burn-in may be minimized or relaxed by the burn-in managing circuit 110 according to exemplary embodiments of inventive concept.

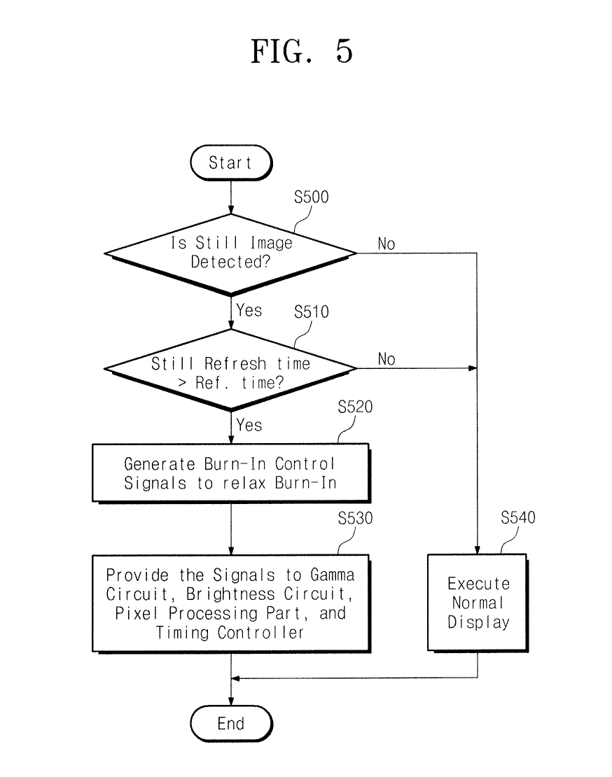

FIG. 5 is a flowchart of burn-in managing control according to an exemplary embodiment of inventive concept. In FIG. 5, operations S500, S510, S520, S530, and S540 are shown as an example of the burn-in manage control. These operations S500 to S540 need not be sequentially performed and may be omitted or changed in order, if necessary.

It is determined whether input image data is detected as a still image (S500). If the input image data is detected as a still image, a check is performed to determine whether the detected still image is maintained longer than a predetermined reference time (S510). That is, the check is performed to determine whether a still refresh time is maintained longer than the predetermined reference time. The operation S510 is performed to decide whether or not to enter a burn-in relax mode. The operation S510 may be performed by the decision circuit 114 in FIG. 3.

A method of detecting whether the input image data is a still image may be accomplished by dividing a single frame into a plurality of unit cells and comparing data in frames of regular intervals with each other. The input image data of a current frame may be determined to be a still image when it is the same as image data of a previous frame or differs from the image data of the previous frame by no more than a threshold amount.

In an exemplary embodiment, a plurality of unit cells displayed in a single frame are set. In a currently input frame, image data corresponding to a unit cell is extracted to be stored as first data. In a frame input after passage of N frames (N being an integer greater than or equal to 2), image data corresponding to a unit cell is extracted to be stored as second data. The previously stored first data and the second data are compared to check whether they are identical to each other. When the first data and the second data are identical to each other, data ‘0’ is set as the first data. When the first data and the second data are different from each other, data ‘1’ is set as the first data. Checking is done to determine whether output values of horizontal comparison data, e.g., three pixel points are all ‘1’. Even when only one of the output values of the horizontal comparison data is not ‘1’, checking is done to determine whether at least four of the output values of the horizontal comparison data are ‘1’. Although it has been described that the output values of the horizontal comparison data are checked, output values of vertical comparison data may be checked. In an exemplary embodiment, when four or more output values of comparison data are ‘1’, it may be set as video (e.g., a moving image). When four or more output values of the comparison data are not ‘1’, it may be set as a still image.

The above-described determination of a still image is merely exemplary, as a determination as to whether input image data is a still image may be accomplished through skip information or other reference information provided together with the input image data.

When it has been decided that the burn-in relax mode is to be entered, the flow proceeds to operation S520. When it has been decided that the burn-in relax mode is not to be entered, a normal display (e.g., a normal display mode) is executed to perform a typical display control (S540).

A burn-in relaxing control signal is generated to relax burn-in of a pixel when the still image has been maintained longer than the reference time period (S520). For example, the burn-in relaxing control signal may be generated by the control signal generator 116 in FIG. 3.

The burn-in relaxing control signal is provided to at least one of a gamma circuit, a brightness circuit, a pixel processing part, and a timing controller, and any combination thereof (S530).

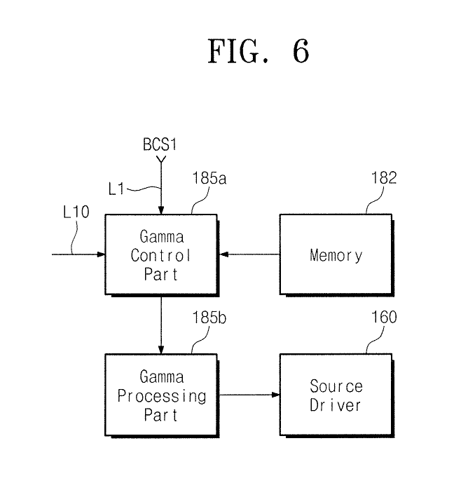

FIG. 6 is a block diagram illustrating an example where a burn-in relaxing control signal generated according to FIG. 5 is used in a gamma circuit 185. As illustrated, the gamma circuit 185 includes a gamma control part 185a, a gamma processing part 185b, and a memory 182.

The gamma control part 185a receives a burn-in relax control signal BCS1 through a line L1 and receives SFR information through a line L10.

The burn relaxing control signal BCS1 is provided with different values when input image data is a still image and when the input image data is not a still image (e.g., video). For example, the burn relaxing control signal BCS1 is a first value when the input image data is a still image and a second other value when the input image data is a moving image. Thus, a gamma level is adjusted such that brightness of a pixel is controlled to relax burn-in.

As a result, the gamma control part 185a determines a gamma level with reference to the memory 182 and outputs a gamma level decision signal to the gamma processing part 185b. In case of a still image, the gamma control part 185a adjusts the gamma level decision signal in response to the applied burn-in relaxing control signal BCS1. Thus, the gamma processing part 185b generates a gamma voltage according to the adjusted gamma level decision signal and applies the gamma voltage to a source driver 160.

Data compensation using a gamma signal is to overcome the disadvantage that due to visual properties, luminance for a specific grayscale is nonlinearly reduced. As a result, gamma compensation is compensation for luminance reduction of an image. According to an exemplary embodiment of inventive concept, gamma compensation is adjusted for burn-in relaxation only in case of a still image, unlike in typical gamma compensation.

The brightness control circuit 190 may receive BCS2, the pixel processing part 170 may receive BCS3, and the timing controller 140 may be receive BCS4.

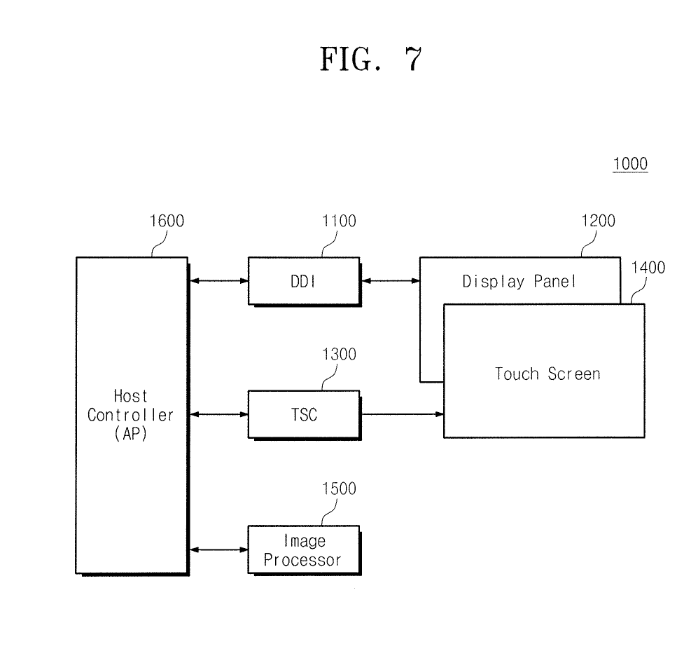

FIG. 7 is a block diagram of an application example applied to a data processing system 1000. As illustrated, the data processing system 1000 includes a display driver integrated circuit 1100, a display panel 1200, a touch screen controller (TSC) 1300, a touch screen 1400, an image processor 1500, and a host controller 1600.

In the data processing system 1000, the display driver integrated circuit 1100 is configured to provide display data to the display panel 1200. The touch screen controller 1300 is connected to the touch screen 1400 overlapping the display panel 1200 and receives sensing data from the touch screen 1400.

The host controller 1600 may be an application processor or a graphic card.

The display driver integrated circuit 1100 to control the display panel 1200 may correspond to the display driving circuit 100 in FIG. 1. Accordingly, burn-in that may occur in a display panel 1200 of the data processing system 1000 may be minimized or relaxed to improve the life of the display panel 1200. As a result, product competitiveness of the system 1000 may be enhanced.

The system 1000 in FIG. 7 may use a mainboard to be implemented with software, firmware, an application specific integrated circuit (ASIC) or a field programmable gate array (FPGA) or any combination thereof. The software or the firmware may be stored by at least one interconnect microchip or integrated circuit, a hardware logic, and a memory device and may be executed by a microprocessor.

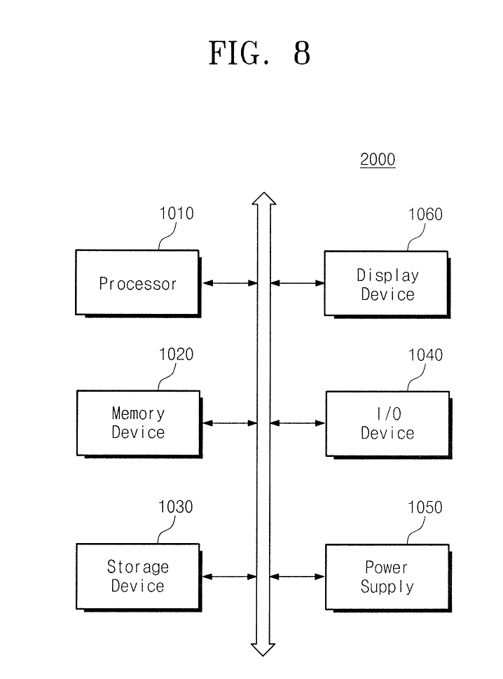

FIG. 8 is a block diagram of an application example applied to a portable computing system 2000. The portable computing system 200 may be a mobile device. As illustrated, the portable computing system 2000 includes a processor 1010, a memory device 1020, a storage device 1030, an input/output device 1040, a power supply 1050, and a display device 1060. The computing system 2000 may further include various ports to communicate with a video card, a sound card, a memory card, and a USB device or communicate with other systems.

The processor 1010 may perform specific calculations or tasks. For example, the processor 1010 may be a mobile SoC, an application processor, a media processor, a microprocessor, a central processing unit or a similar device. The processor 1010 may be connected to other components through an address bus, a control bus, and a data bus. In an exemplary embodiment, the processor 1010 is connected to an extension bus such as a peripheral component interconnect (PCI) bus.

For example, an interface between the processor 1010 and the memory device 1020 may be one of a USB (Universal Serial Bus) protocol, an MMC (Multimedia Card) protocol, a PCI (Peripheral Component Interconnection) protocol, a PCI-E (PCI-Express) protocol, an ATA (Advanced Technology Attachment) protocol, an SATA (Serial ATA) protocol, an ESDI (Enhanced Small Disk Interface) protocol, and an IDE (Integrated Drive Electronics) protocol.

The memory device 1020 may store data required for operation of the portable computing system 2000. The storage device 1030 may include at least one of a solid state drive (SSD), a hard disk drive (HDD), and a CD-ROM.

The input/output device 1040 may include input means such as a keyboard, a keypad, a touchpad, a touch screen, and a mouse and output means such as a speaker and a printer. In an exemplary embodiment, the display device 1060 is located within the input/output device 1040.

The power supply 1050 may supply power required for operation of the portable computing system 2000.

The display device 1060 may be connected to other components through the buses or other communication links. The display device 1060 may correspond to the display driving system in FIG. 2. Accordingly, burn-in that may occur in a display panel may be minimized or relaxed to improve the life of the display panel.

In an exemplary embodiment, the computing system 2000 may be implemented with an electronic device such as digital television (TV), 3D TV, personal computer (PC), a home electronic appliance, a laptop computer, a tablet computer, a mobile phone, a smartphone, a personal digital assistant (PDA), a portable multimedia player (PMP), a digital camera, a music player, a portable game console, or a navigation system.

The memory device 1020 or the processor 1010 in FIG. 8 may be mounted using various types of packages. As described so far, burn-in that may occur in a display panel is minimized or relaxed to improve the life of the display panel.

While embodiments of the inventive concept have been particularly shown and described with reference to particular embodiments thereof, it will be understood that various changes in form and details may be made therein without departing from the spirit and scope of the inventive concept. For example, it is possible to adjust an OLED display device by changing, adding, or removing the circuit configuration or arrangement in the drawings without departing from the technical spirit.

What is claimed is:

1. A display driving circuit comprising:
a gate driver configured to output a scanning signal;
a source driver configured to output image data;
a timing controller configured to control the gate driver and the source driver to display the image data; and
a burn-in managing circuit configured to determine whether input image data to be applied to the source driver is a still image to decide whether or not to enter a burn-in relax mode and to generate a burn-in relaxing control signal for burn-in relaxation according to a result of the decision.

2. The display driving circuit as set forth in claim 1, wherein
the burn-in managing circuit analyzes input image data applied to a graphic memory from a host to determine whether the input image data is the still image.

3. The display driving circuit as set forth in claim 1, wherein
the burn-in managing circuit analyzes input image data output from a graphic memory receiving the input image data from a host and storing the input image data in a storage area of the graphic memory to determine whether the input image data is the still image.

4. The display driving circuit as set forth in claim 1, wherein
the burn-in managing circuit includes an input detector configured to detect whether input image data received from a system-on-chip is a still image or detect whether input image data output from a graphic memory is the still image.

5. The display driving circuit as set forth in claim 1, wherein the burn-in managing circuit comprises:
a first input detector configured to detect whether input image data received from a host is the still image;
a second input detector configured to detect whether input image data provided to the source driver from a graphic memory is the still image;
a decision circuit configured to decide whether or not to enter the burn-in relax mode in response to detection outputs of the first and second detectors; and
a control signal generator configured to generate the burn-in relaxing control signal for burn-in relaxation of a display panel in response to a decision result of the decision circuit.

6. The display driving circuit as set forth in claim 1, wherein
entering the burn-in relax mode is executed when the still image is determined and maintained longer than a predetermined reference time.

7. The display driving circuit as set forth in claim 1, wherein
the burn-in relaxing control signal is applied to a gamma circuit adjusting a gamma level to control the brightness of a display panel.

8. The display driving circuit as set forth in claim 1, wherein
the burn-in relaxing control signal is applied to a brightness circuit adjusting a power supply voltage of a display panel to control the brightness of the display panel.

9. The display driving circuit as set forth in claim 1, wherein
the burn-in relaxing control signal is applied to a pixel processing part regenerating display data and outputting the display data to the source driver to control the brightness of a display panel.

10. The display driving circuit as set forth in claim 1, wherein
the burn-in relaxing control signal is applied to a timing controller adjusting an organic light emitting diode OLED emission pulse width modulation PWM to control the brightness of a display panel.

11. A display driving system comprising:
a host;
a display driving circuit; and
a display panel, wherein the display driving circuit comprises a burn-in managing circuit configured to determine whether applied image data is a still image or a video to decide whether or not to enter a burn-in relax mode and to generate a burn-in relaxing control signal for burn-in relaxation according to a result of the decision.

12. The display driving system as set forth in claim 11, wherein the burn-in managing circuit analyzes input image data applied to a graphic memory from a host to determine whether the input image data is a still image or analyzes input image data output from a graphic memory receiving input image data from a host and storing the input image data in a storage area of the graphic memory to determine whether the input image data is a still image.

13. The display driving system as set forth in claim 11, wherein the burn-in managing circuit comprises:
a first input detector configured to detect whether input image data received from a host is a still image;
a second input detector configured to detect whether input image data provided to the source driver from a graphic memory is a still image;
a decision circuit configured to decide whether or not to enter a burn-in relax mode in response to detection outputs of the first and second detectors; and
a control signal generator configured to generate the burn-in relaxing control signal for burn-in relaxation of a display panel in response to a decision result of the decision circuit.

14. The display driving system as set forth in claim 11, further comprising:
a pattern refresh circuit configured to refresh a specific pattern to the display panel when entering the burn-in relax mode.

15. The display driving system as set forth in claim 11, further comprising:
a frame rate adjuster configured to variably adjust a frame rate of the display panel when entering the burn-in relax mode.

16. A display driving circuit comprising:
a gate driver configured to output a scanning signal;
a source driver configured to output image data;
a timing controller configured to control the gate driver and the source driver to display the image data; and
a burn-in managing circuit configured to determine whether input image data to be applied to the source driver is a still image or a moving image, apply a signal at a first level to enter a burn-in relax mode when it determines the input image data is the still image, and apply the signal at a second other level to exit the burn-in relax mode or enter a normal display mode when it determines the input image data is the moving image.

17. The display driving circuit of claim 16, further comprising a plurality of internal signal lines, wherein the burn-in managing circuit is configured to apply the signal to a selected one of the internal signal lines.

18. The display driving circuit of claim 17, wherein the selected one of the internal signal lines connects the burn-in managing circuit to the timing controller, and the signal causes the timing controller to set a pulse width modulation signal to change a pixel brightness of one or more pixels of a display panel when the signal is applied at the first level and maintain the pixel brightness when the signal is applied at the second level.

19. The display driving circuit of claim 17, further comprising a gamma circuit, wherein the selected one of the internal signal lines connects the burn-in managing circuit to the gamma circuit, and the signal causes the gamma circuit to change a gamma level when the signal is applied at the first level and maintain the gamma level when the signal is applied at the second level.

20. The display driving circuit of claim 17, further comprising a brightness circuit, wherein the selected one of the internal signal lines connects the burn-in managing circuit to the brightness circuit, and the signal causes the brightness circuit to change a power supply voltage of a display panel when the signal is applied at the first level and maintain the power supply voltage when the signal is applied at the second level.
